(19) United States
(12) Patent Application Publication
(10) Pub. No.: US 2022/0261927 A1
(43) Pub. Date: Aug. 18, 2022

(54) Speed Dating Platform with Dating Cycles and Artificial Intelligence

(71) Applicant: Lynk Technology Holdings, Inc., Dallas, TX (US)

(72) Inventors: Jeff Emile, Los Angeles, CA (US); Mark Brown, Los Angeles, CA (US)

(21) Appl. No.: 17/670,993

(22) Filed: Feb. 14, 2022

Related U.S. Application Data
(60) Provisional application No. 63/149,266, filed on Feb. 13, 2021.

(51) Int. Cl. G06Q 50/00; H04N 7/14; H04L 67/306

(52) U.S. Cl. CPC G06Q 50/01; H04L 67/306; H04N 7/147

(57) ABSTRACT

Examples can include a system for video chat cycles within a social media application. The application can pair users for video chats in a dating cycle where multiple users perform multiple chats in succession. The pairing can be based on common interests that can be predetermined based on likes and posts within a feed. Artificial intelligence bots can also participate in the dating cycles when another matching user is unavailable. Additionally, a last looks screen can allow the user to adjust their appearance and can provide options based on interests of other users likely to be paired with the user in the dating cycle.

### CROSS-REFERENCE TO RELATED APPLICATION

This application claims the benefit of and priority to U.S. Provisional Application No. 63/149,266, titled “Speed Dating Platform with Dating Cycles and Artificial Intelligence,” filed Feb. 13, 2021, the contents of which are hereby incorporated by reference in their entirety.

### BACKGROUND

People are constantly looking for new ways to connect and meet with compatible mates. Doing so has become more difficult as people's lives have become busier. Existing social media platforms and dating applications have also contributed to isolating social patterns and paradoxically have made it more difficult in some situations to establish meaningful relationships. Users of dating applications either fail to initiate meaningful conversation or end up on a full date with someone that they quickly realize is incompatible. Currently technologies do not provide a way to quickly meet multiple potential matches in a meaningful enough way. As a result, users cannot easily narrow down individuals to determine who to invest more time with.

Additionally, many people are drawn to dating-based reality television shows. People enjoy watching others attempt to interact on dates, which can yield useful insight that may spare a person from making similar mistakes. However, this such reality television does not apply to online dating. Currently, no online dating platforms integrate any way for a user to build confidence that may be necessary for the user to successfully engage with others on the platform. Instead, users typically must attempt to navigate the platform by interacting with other users that may be more familiar with the online dating, which can lead to early negative results that disincentivize further engagement with the dating platform.

### SUMMARY

The examples described herein specifically address technical problems and limitations of current dating platforms. The examples include a computing device, such as a personal computer, tablet, or laptop, that executes a dating application. The application can be installed on the device or can be a web application. A server can match the user with other users on the system and perform a series of video chats as part of a dating cycle.

In one example, to perform the dating cycle the application can receive input that the user would like to join an upcoming dating cycle. This can include a profile setting that the user sets. The social media application can include a feed where the user can browse posts by other users, create their own posts, comment, and like posts. When a user is active in the feed, such as browsing or commenting, the user can be active for a dating cycle. Alternatively, the user can explicitly join a dating cycle or event with a dating cycle.

The application can match users based on common interests. This can include pre-determined interests that are based on the users' activities in the feed. For example, topics that the user tends to read about, post about, or like can be identified by a matching engine and added as interests to the user profile. In one example, two users that commonly view the same groups or other user's posts can be weighted positively for matching.

When the cycle is set to begin, a graphical user interface (“GUI”) can show the user their “last looks,” which can be current video of the user as received. The GUI can present options for the user to change their appearance. The options can be tailored to one of the identified matching user's preferences, in an example.

After the dating cycle of multiple video chats is complete, the first user can be presented with an option to link with one or more of the other users that the first user chatted with.

### BRIEF DESCRIPTION OF THE DRAWINGS

FIG. 1 is an example flow chart showing example stages for a dating cycle.

FIG. 2 is an example flow chart showing example stages for a live date.

FIG. 3 is an example flow chart showing example stages for introducing a bot user in the dating cycle.

FIG. 4 is another example flow chart for using a bot user in the dating cycle.

FIG. 5 is an example illustration of system components.

FIG. 6 is an example illustration of GUI screens for speed dating.

FIG. 7 is another example illustration of GUI screens for speed dating.

The Appendix includes additional examples.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

An attached Appendix describes an exemplary solution and should not be read in a limiting fashion. Additional notes also follow the below discussion, prior to the three sections of example claims.

The speed dating can be carried out by a server that communicates with multiple user devices. The user devices can execute dating applications that exchange information with the server. The dating application can also execute as a web-based application in an example, such as by using a browser or a hybrid client-side application. Likewise, the server can include one or more webservers in an example.

The dating application can allow the user to engage in a dating cycle. For example, a dating cycle can include multiple short independent video interactions, such as five consecutive 60 second chats with different users. Users can be matched based on an algorithm that chooses from a pool of available users in the system during any given session and places them into a disbursement pool. A matching engine will then take into account the predetermined preferences a user has indicated on their profile and launch fitting pairs of users from the disbursement pool to create individual dates.

As will be described below, the dating cycle can provide a user with a last look at themselves to make any adjustments before the first of the video chats begins. The last looks screen can prompt the user regarding appearance, lighting, or background noise to help the user make a positive impression. Users can also artificially manipulate their image using built in tools, in an example. The video chats themselves can include options for sending gifts to a dating partner. These gifts can be symbolic or actual. Additionally, the user may elect to allow spectators. Spectators can then watch dates where the pair of users have agreed to spectators, with spectators also being allowed to send gifts to the users participating in the dates.

When the series of video chats ends, live date stats can be displayed. The user can indicate whether they are interested in matching with some subset of their dating partners from the series of video chats. If the pair of users both indicate one another, then they are added to each other's preferred list. Dates can remain on the preferred list for a period of time and be contacted by text, video, or phone through selecting the user in the preferred list from within the dating application.

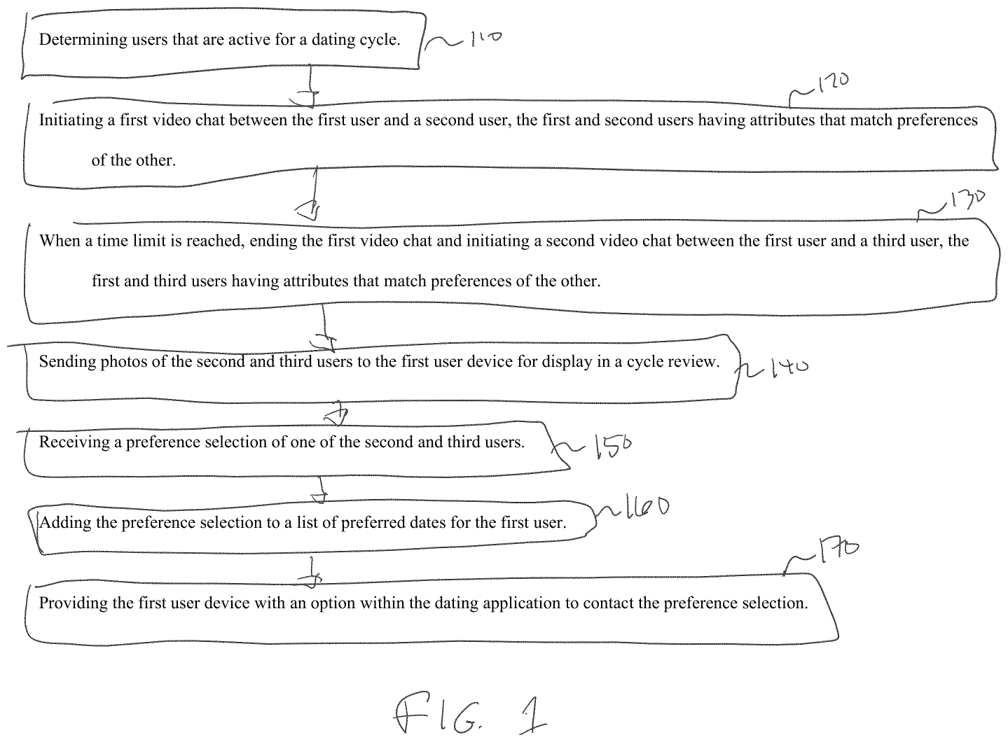

FIG. 1 is an example flow chart for speed dating from the perspective of the server. Multiple users can access a dating application or a browser that communicates with the server. The users can elect to being a dating cycle. The dating cycle can include multiple consecutive video chats with different users that the server determines meet user requirements.

At stage 110, the server can determine users that are active for a first user's dating cycle. In one example, users can all be logged into the platform with either a setting or selection that indicates they are available for a dating cycle. For example, the user profile can include a toggle option that indicates they are available while on the platform. The platform can include a feed of posts and other engaging content that the user can interact with or add to, in an example. The client-side application, such as the web browser or application installed on a phone, can track the user's activity on the feed. If the user is engaging with the feed by scrolling, clicking, or posting and the user setting indicates they will participate in dating cycles, the application can report that the user is active.

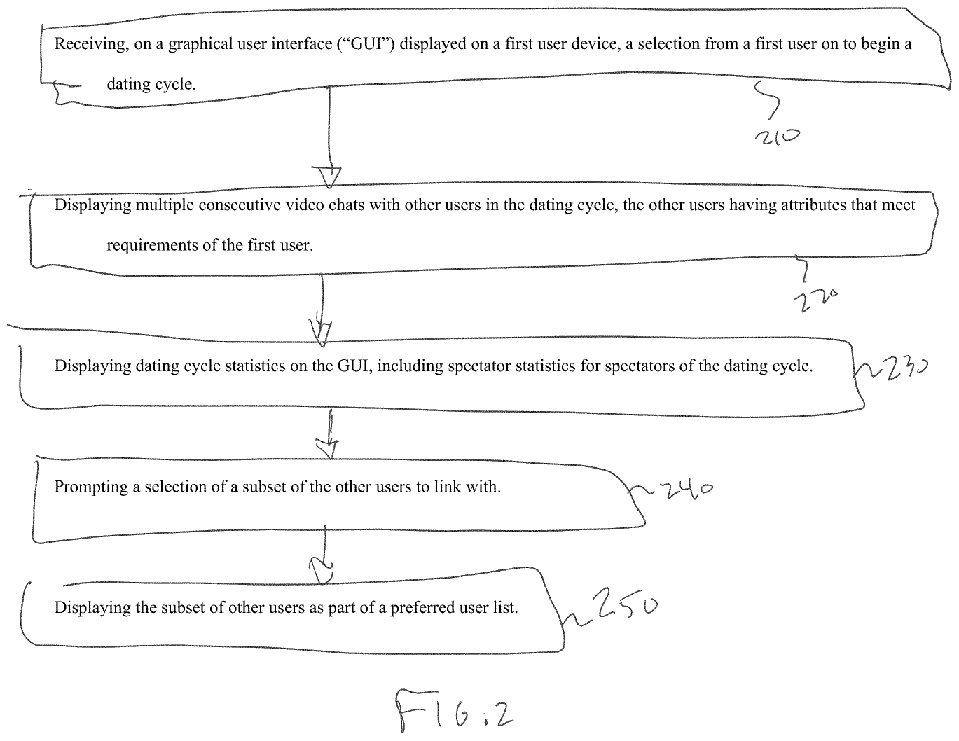

In one example, the application can notify the user that they are active, and a dating cycle is beginning. They can be shown a “last looks” screen or pane in the foreground of the feed portion of the application that allows the user to explicitly approve they are ready for the dating cycle after seeing themselves. The first user can also become active based on indicating they are ready for their first date from within the “last looks” screen. Last looks are discussed in more detail with regard to stage 210 of FIG. 2, but in general the dating application can utilize a camera on the user device to allow the first user to view themselves one last time before the dating cycle begins. The last looks screen can include prompts to help the user with making a positive impression. This can include monitoring lighting, sound, and providing tools for virtually altering the user's video appearance or their background.

The server can determine which users are active for pairing with the first user for a date within the dating cycle. This can include monitoring which users are not already in a date (i.e., video chat) but need an additional date to reach the total for their respective dating cycle. The available users can be treated as “active,” in an example.

In addition to determining which users are active (e.g., available), a matching engine on the server can attempt to find ideal matches between users. This can include first meeting required attributes that the user can set in a profile, such as gender, age, and geographic location. The match needs to work both ways between the pair of potential users for the date. In addition, the matching engine can consider other attributes, such as interests and particular desired attributes of a partner. These attributes and either be set by the user or can be learned by the system. For example, a machine learning model can review video chats for each user and determine which topics or partner attributes seem to cause a user to select a match (e.g., a preferred user) for further follow-up at the conclusion of the dating cycle.

In another example, feed activity can be used to determine matches between users. For example, users that monitor similar threads, groups, and posts can be weighted for matching. However, if the user has already been matched with another user, that can weight against matching. This can help match users that have common interests.

At stage 120, the server can initiate a first video chat between the first user and a second user, with both of the first and second users matching the preferences of the other. The server can authenticate both devices and cause a video chat to occur between the devices. The video chat itself can be hosted on a system server, in an example. These hosting servers can execute in the cloud, in an example.

In one example, the video can display known common interests between the users based on their feed usage. For example, if both users have been responding to posts about kayaking, the video chat can include text that states “Common interests: kayaking.” The engine can develop user interest data by periodically tabulating points for various topics, in an example. An algorithm can consider keywords in posts that are created or liked by a user and image recognition for images and videos posted and liked by the user to determine categories of interest for that user. Additionally, when a first user seeks out or likes posts by a third user, the third user can be associated with the first user as an interest. If the first user and second user are both interested in the third user based on past feed activity, this can be used to positively weight the potential match between the user are that other user.

In another example, background music can play that is selected based on a common interest of the first and second users. For example, if both users liked a song or a band within the feed or in a third-party application where such information is available by application programming interface (“API”) calls, the speed date can play that song or band at low volume in the background.

Generally, by using common interests determined from feed activity of the first and second users, the application can present guiding text regarding those interests or the background music. This can help the first and second users quickly identify something to start talking about that they can feel reasonably sure the other is interested in. This provides a level of comfort that may not exist in purely randomized conversations, allowing the users to each get more out of the brief interaction.

The video chat can include a short time limit, such as one minute. At stage 130, when the time limit is reached, the first video chat can end, and the server can initiate a second video chat for the first user. As before, the server can attempt to find an active user that meets the preferences of the first user. Then the second video chat between the first user and a third user can occur, the first and third users each having attributes that match preferences of the other. Likewise, the second user can be matched for another video chat if they have not yet met their quota of dates to complete the dating cycle (e.g., five dates).

The matching engine can then be given audio or a transcript of the video chat for processing. The matching engine can attempt to identify topics discussed for scoring user interests for future matches. The interest level for a topic can be gauged based on how much either user spoke on the topic combined with whether the first and second users make a preference selection based on the conversation at stage 150. The conversations can also be used to provide feedback to the user, such as making sure to give the other users a chance to talk when it appears that the first user has one-sided conversations more than a threshold percentage of the time. A one-sided conversation can be indicated when at least 75 percent of the talking is done by one of the users, in an example. When the first user is identified as dominating the conversations, the application can attempt to notify the user during a video date when the user is continuing to dominate the conversation. For example, text that only the first user can see can be displayed that says, “make sure Stephanie08 gets a chance to speak.”

Stage 130 can repeat until the first user has achieved the total number of dates needed for the dating cycle or until no additional active users with matching criteria are present. In another example, the user can elect to end the dating cycle and return to the feed.

At stage 140, the server can provide information that allows the first user to review the dates of their dating cycle. This can include sending photos of the second and third users to the first user device for display in a cycle review. The photos can help the user remember who each date pairing was. Additionally, statistics such as gifts given by a date or by spectators of a date can be shown with respect to the pictures representing the users of the individual dates.

The live date stats can assist the user with determining which of the dating partners to select as a desired match. For example, at the completion of each live date or at the end of the dating cycle, the statistics can display. The statistics can include one or more of the following

1. The total number of viewers the stream had.

2. The total amount of comments the stream had.

3. The total amount of hearts that were shared during the stream.

4. The total amount of gifts that were shared during the stream.

5. The total amount of gifts sent to an individual user.

6. The total amount of hearts sent to an individual user.

In addition, on the live date stat screen a graph can show highest and lowest engagement/interaction levels on a y axis, and the minutes on the x axis. This can help a user determine whether they were correct in thinking that a date went well or poorly. Additionally, in some examples a user can re-watch a stream in conjunction with the live stat graph overlayed to better understand what went well or poorly in a date.

At the conclusion of the dating cycle, the dating application can then prompt the first user to select which ones of the users from the dating cycle that the first user hopes to match with. The first user can be forced to select only a maximum of a subset (e.g., three) of the total dates (e.g., five). The selection screen can include a time limit, such as 30 seconds.

At stage 150, the server can receive a preference selection (i.e., desired match) from the user device. The desired match can be at least one of the second and third users in an example. The system can store the selection and wait for similar selections from the other users that participated in the dates (e.g., their respective dating cycles may still be taking place). If a selected user also selects the first user at the end of their respective dating cycle, then the system can create a match between users that allows for further correspondence within the dating application.

In one example, at stage 160 the server can add the selected second user to a preferred dates list for the first user (assuming the second user also selected the first user). The preferred dates list can display within the dating application. When users select the name of a preferred date, they can be given options to text, call, or video chat that user depending on what each user has allowed for follow-up contact. These options can be provided within the dating application at stage 170.

After a period of time of no contact, preferred dates can fall off of the list to keep it from getting cluttered or too long.

FIG. 2 is an example flow chart for speed dating from the perspective of the dating application (and user device). At stage 210, the dating application can receive, on a graphical user interface (“GUI”) displayed on a first user device, a selection from a first user on to begin a dating cycle. This can occur as part of the “last looks” GUI screen, in an example. The last looks screen can display after the user selects to start dating, in an example. Then the user can verify that they are ready after making any needed adjustments based on the last looks screen.

As mentioned above, the last looks screen can allow the user to view and modify their own image prior to the dates beginning. For example, for females the last looks screen can remind the user to make sure they have some makeup on. But beyond simple tips, the last looks screen can also check lighting levels and sound levels and prompt the user to make technical adjustments. In one example, the dating application can measure lighting levels or ensure that facial features can be recognized by the camera. This can allow the dating application to prompt the user to raise or lower the lighting levels. Similarly, while the last looks screen is active, the dating application can check for levels of background noise and warn the user if background noise is detected. The last look screen can let the user know when the lighting and background noise levels are appropriate, in an example.

Last looks adjustment options can include artificial reality options to access various filters to enhance the user's image or background. This can include fun templates with trinket such as glasses, goggles, hats, and other items. Users can use artificial reality to change their background, allowing them to be placed in different digital spaces. Users can also alter the tone and pitch of their voice, allowing them to change the sound of their voice. Using artificial reality, users can add virtual make-up, facial hair, or remove the appearance of hair. In one example, users can also select from a predetermined library of music to reflect their mood.

In one example, the artificial reality option is suggested based on predetermined interests of one or more users that the matching engine is pairing or could potentially pair with the first user. For example, if a second user enjoys feed posts about rabbits, a pair of bunny ears can be suggested to the first user. Alternatively, if the second user tends to like images of women with dark features, a filter to darken the features of the first user can be suggested.

After the user finishes checking themselves or making the above adjustments, they can press the “continue” button to start their dating cycle.

At stage 220, the dating application can display multiple consecutive video chats with other users in the dating cycle, the other users having attributes that meet requirements of the first user. As described in FIG. 1, this can continue until the quota of dates is met for the user's dating cycle.

Stage 220 can also include allowing spectators to view the dates. Users can select whether to broadcast their dates. In some cases, spectators can favorite users and watch those users' dates based on a “featured cycles” list. For example, the dating application or website can feature celebrities, social media influencers, and favorited users such that spectators can select which upcoming or ongoing date cycles to watch. The dates can be displayed in a featured feed, where spectator users will be able to click and watch, send gifts, leave comments, and interact with one another.

By using user data such as indicated preferences and interest, the system can showcase celebrities and social media influencers that a specific user will have a higher probability of interacting with. By using user data such as indicated preferences and interest the system can additionally deliver in and out of app notifications to users, notifying them of a stream that they would be interested in. This can feature a probability match, indicating to the user that based on their preferences they may enjoy watching the stream.

During dates, the participant or spectator users can give gifts in an example. For example, once on a cycle or watching a live date, users can send virtual gifts that they have purchased in the in-app gift store, and have that gift be displayed on screen in real-time as they give it. The receiving user of a gift has the ability to convert the gift into points that they can cash-out through an in-app conversion process. Money can be distributed to the users bank account through a third-party service. Through integrating public API's in the app, users will be able to purchase tangible gifts, coupons and food items through services such as Uber Eats, DoorDash, and other delivery services. These gifts can then be physically delivered to the user's address without the user having to reveal their address to dating partners on the system that they may not know well yet.

At stage 230, the GUI can display dating cycle statistics on the GUI, including spectator statistics for spectators of the dating cycle. Then, at stage 240, the GUI can prompt a selection of a subset of preferred users from the dating partners of the dating cycle. If a match exists, the user can be added to a preferred date list. At stage 250, the GUI can display the preferred date list, allowing the user to further correspond with the matched preferred dates.

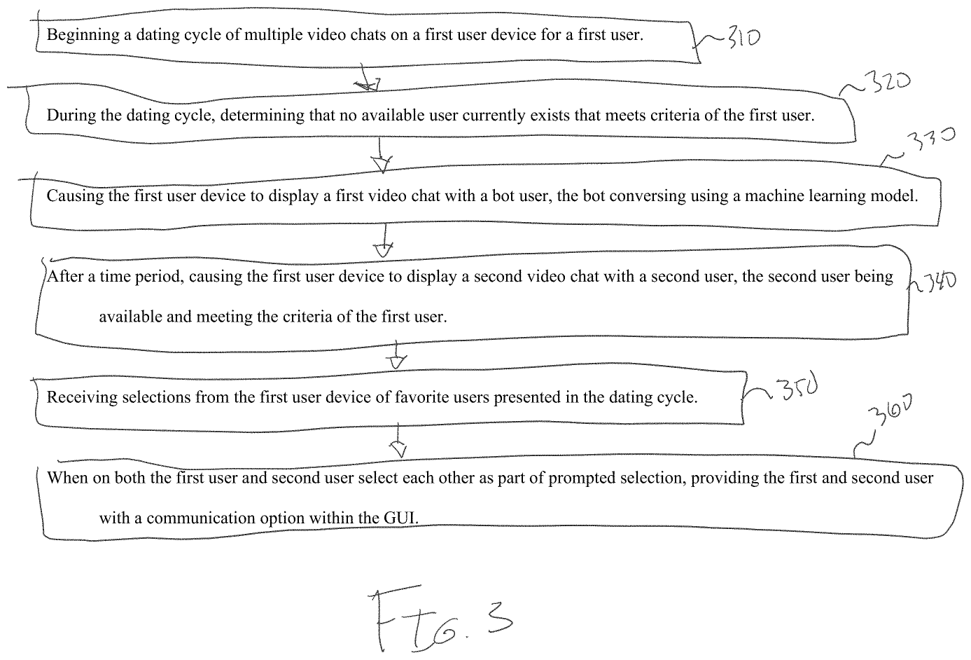

FIG. 3 is an example flow chart for adding bot users into dating cycles. Upon user selection, a user can have Artificial Intelligent (AI) Bots Intermixed within their dating cycles. This can provide valuable practice to the user and can help the system better understand attributes of the user for creating matches with other users.

The bot users can be rendered visually in the video chats, such as with a 2-D rendering, a 3-D rendering, or photorealistic animation of a human being. The bot user can change its physical appearance such as hair style, hair length, hair color, make-up, lip stick, and other physical qualities based on user commands or requests. These commands can be examined by the machine learning algorithm to generate user preferences.

Bot users can be selected purely for practice in one example. However, in another example, at stage 330 the system can select a bot user when no other matching active user is available.

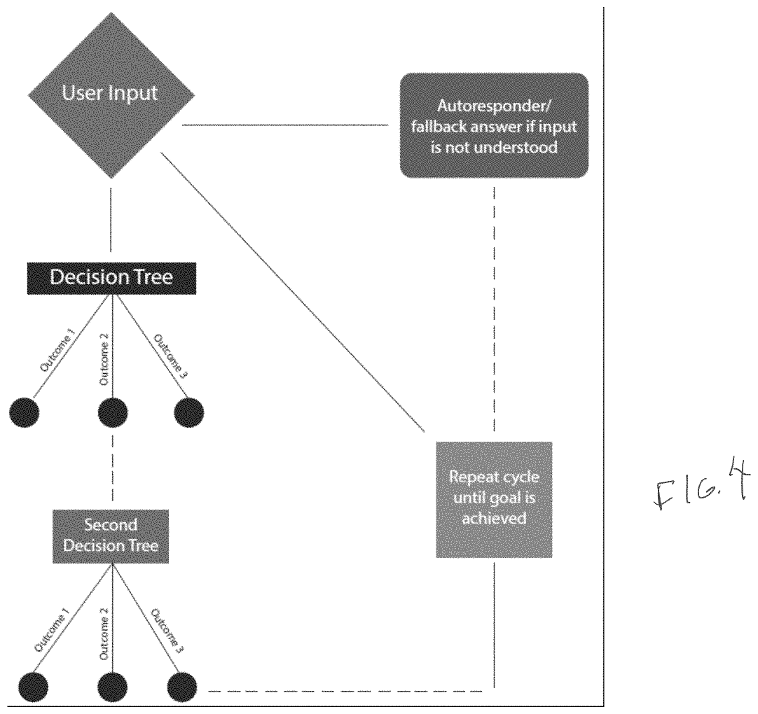

FIG. 4 is an example flowchart for communication by a bot user with a real user. The bot users can communicate with users via text and voice. Upon receiving a user input by either text or voice, the artificial intelligence (“AI”) Bots can be programmed to use an outcome probability program that is based on pre-written scripts. The AI Bot will determine an answer that best suits the input it received. This cycle will repeat until either the user, or the bot stops responding to the conversation.

If the user sends a message that the AI Bot does not understand, the AI Bot will default to an auto response, or a fallback answer. The AI Bot can have a memory of everyone it has spoken to, allowing it to recall former chat history and bring up/reference older conversations. The AI bots can use Machine Learning to adapt to the different answers it receives, and in turn learn how to apply different answers in different situations.

The AI Bot will be programmed to perform various transactions including but not limited to financial translations where it can send users virtual gifts to their account, as well as physical gifts through connected API services in the app. An example of this would be an AI Bot sending a user a digital bouquet of roses, or sending a user french fries through a service such as UberEats, or DoorDash.

In one example, the AI Bot can utilize the pre-determined interests of the user to steer conversation. For example, if the first user has an interest in kayaking, the AI Bot can ask the user whether they recently saw a post in the kayaking group regarding a steel bridge on the Chattahoochee River. In one example, the AI bot can ask the user what the user thought about a question in that post thread or ask the user about one of the replies that got a lot of feedback. If the user makes a statement indicating that they do not care, then the AI bot can ask about a different user interest or about a topic that the user has posted on within the feed.

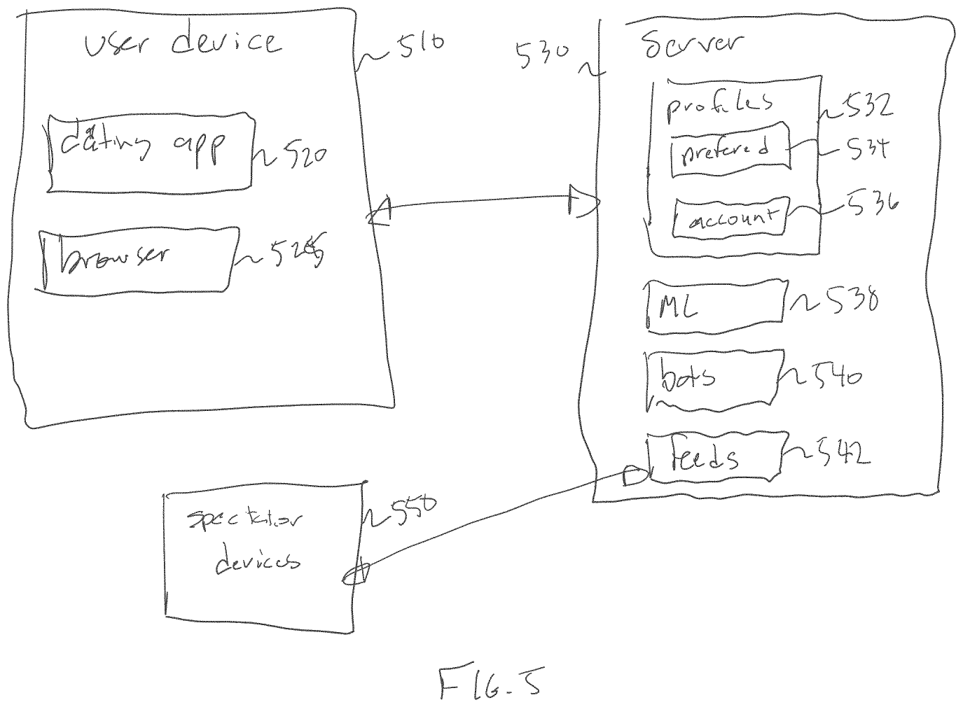

FIG. 5 includes an exemplary diagram of a system in accordance with an example. Multiple user devices 510, 550 can connect to the server 530 as part of executing a dating application 520. A user device 510, 550 can be any processor-based device, such as a personal computer, laptop, tablet, or cell phone. The user device 510can display the dating application GUI by executing a set of instructions stored locally or remotely on a computer-readable medium.

The server 530 can alternatively be accessed by a browser 525 in an example. It is understood that the dating application 520 can be a web application provided by the server 530 for execution in the browser 525, in an example.

The server 530 can include one or more servers operating in the cloud, in an example. Physical hardware can execute virtual servers in an example.

The server 530 can store and track user profiles 532 that can accumulate user preference information 534 and can include information about the user's account 536. The preference information 534 can include interests that have been scored by a machine learning algorithm or model 536. The interests can constantly be updated based on user interaction in the feed, in an example. When a user likes a post, scores for interests can adjust to reflect that the user is interested in the poster and in the topic. The topic can be discerned from either or both of a group where the post is located and keywords and images within the post.

A machine learning algorithm or model 538 can be used as part of a matching engine for selecting date matches between users based on the preferences 534. The model 538 can also be used by the matching engine to update the user interests in the profile 532. The profile 532 can also track which users the first user has already talked during a dating cycle. Whether either user wanted to link or whether either did not want to talk to the other again can also be tracked and used for determining future matches.

Additionally, a bot 540 can utilize an ML model 538 and user preferences 534 to converse with the user. Video feeds 542 can be managed by the server 530 and also broadcast to spectator devices 550, in an example.

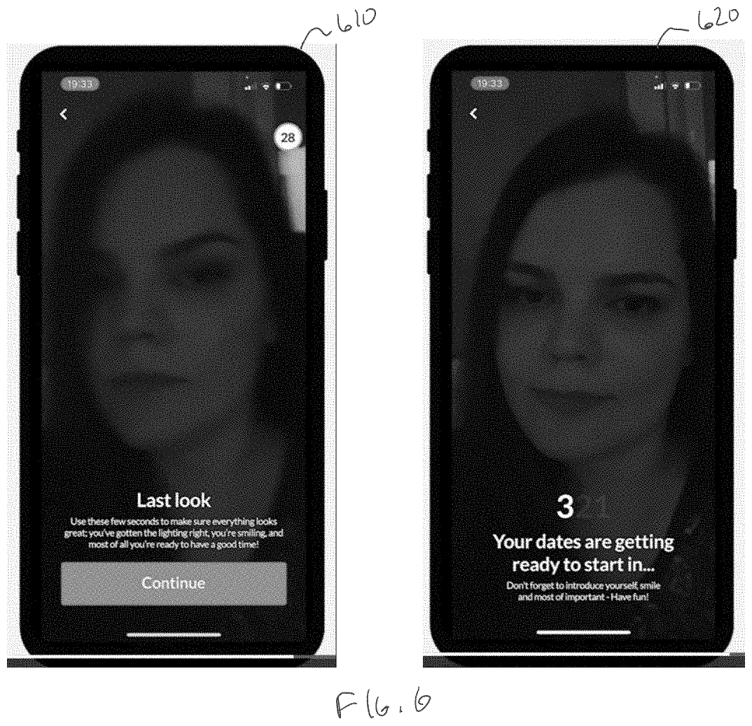

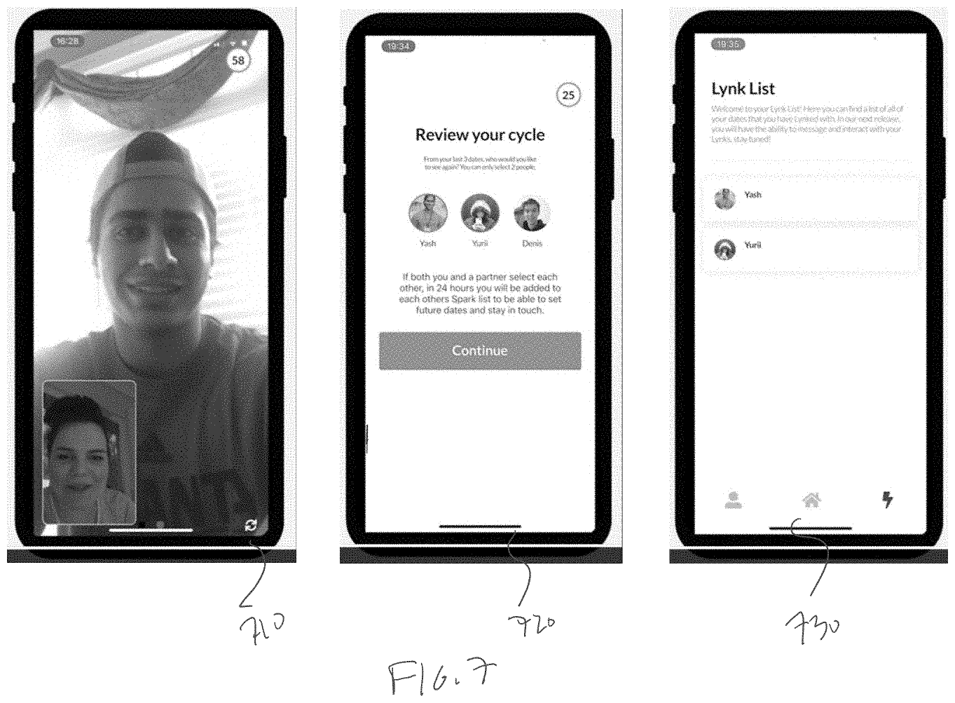

FIGS. 6 and 7 include example GUI screens. Screens 610 and 620 are “last looks” screens. In one example, the last looks are displayed as a window over the top of a feed where the user is actively reading, reacting, and posting. This can serve as notice the user that they are soon to be paired up in a live date.

Screen 710 shows a video chat (date) that is part of a date cycle. Screen 720 is a cycle review screen that allows the user to select preferred matches. Screen 730 shows a preferred date list.

Other examples of the invention will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the invention being indicated by the following claims.

1. A system for speed dating, including:
a database that stores user profiles;
a processor that executes instructions to perform stages comprising:
determining users that are active for a dating cycle, including a first user associated with a first user device;
initiating a first video chat between the first user and a second user, the first and second users having attributes that match preferences of the other;
when a time limit is reached, ending the first video chat and initiating a second video chat between the first user and a third user, the first and third users having attributes that match preferences of the other;
sending photos of the second and third users to the first user device for display in a cycle review;
receiving a preference selection of one of the second and third users;
adding the preference selection to a list of preferred dates for the first user; and
providing the first user device with an option to contact the preference selection.

2. The system of claim 1, wherein the matching preferences include a shared interest that is predetermined based on activities by the first user and second user in a feed of posts.

3. The system of claim 1, wherein the dating application presents a last look of the first user prior to the user being active for the dating cycle, and wherein the first user becomes active by selecting an option to begin the dating cycle while being presented with the last look.

4. The system of claim 3, wherein the dating application detects lighting levels and notifies the first user during the last look when more or less lighting is needed.

5. The system of claim 3, wherein the last look includes an option for applying artificial reality to an image of the first user, and wherein the option is presented to the first user based on a predetermined interest of the second user.

6. The system of claim 3, wherein the last look includes an option for changing a voice tone or a voice pitch of the first user.

7. The system of claim 1, wherein the first video chat includes background music that is selected based on a predetermined common interest of the first and second users.

8. The system of claim 1, wherein an interest of the first user is updated based on text analysis of the conversation associated with the preference selection of the first user.

9. The system of claim 1, wherein determining users are active includes determining the users are all currently participating in a feed.

10. The system of claim 1, wherein the third user is an artificial intelligence bot, wherein the artificial intelligence bot converses with the first user based on predetermined interests of the first user, and wherein the appearance of the artificial intelligence bot is selected based on prior likes of the first user relative to images of real humans.

11. A method for speed dating, comprising:
determining users that are active for a dating cycle, including a first user associated with a first user device that executes a dating application;
initiating a first video chat between the first user and a second user, the first and second users having attributes that match preferences of the other;
when a time limit is reached, ending the first video chat and initiating a second video chat between the first user and a third user, the first and third users having attributes that match preferences of the other;
sending photos of the second and third users to the first user device for display in a cycle review;
receiving a preference selection of one of the second and third users;
adding the preference selection to a list of preferred dates for the first user; and
providing the first user device with an option within the dating application to contact the preference selection.

12. The method of claim 11, wherein the dating application presents a last look of the first user prior to the user being active for the dating cycle, and wherein the first user becomes active by selecting an option to begin the dating cycle while being presented with the last look.

13. The method of claim 12, wherein the dating application detects lighting levels and notifies the first user during the last look when more or less lighting is needed.

14. The method of claim 12, wherein the last look includes an option for changing a voice tone or a voice pitch of the first user.

15. The method of claim 11, wherein the first video chat includes background music selected based on a common interest between the first and second users, the common interest including a band or a song.

16. A non-transitory, computer-readable medium containing instructions for speed dating, the instructions causing a processor to execute stages comprising:
determining users that are active for a dating cycle, including a first user associated with a first user device that executes a social media application;
initiating a first video chat between the first user and a second user, the first and second users having attributes that match preferences of the other;
when a time limit is reached, ending the first video chat and initiating a second video chat between the first user and a third user, the first and third users having attributes that match preferences of the other;
sending photos of the second and third users to the first user device for display in a cycle review;
receiving a preference selection of one of the second and third users;
adding the preference selection to a list of preferred dates for the first user; and
providing the first user device with an option within the social media application to contact the preference selection.

17. The non-transitory, computer-readable medium of claim 15, wherein the social media application presents a last look of the first user prior to the user being active for the dating cycle, and wherein the first user becomes active by selecting an option to begin the dating cycle while being presented with the last look.

18. The non-transitory, computer-readable medium of claim 16, wherein the last look includes prompts for improving an appearance of the first user, and wherein the option to being starts a countdown timer that displays in the social media application.

19. The non-transitory, computer-readable medium of claim 16, wherein the first user is determined to be active based on the first user scrolling within a feed of the social media application, and wherein the first and second users are matched based on portions of the feed that both the first and second user have viewed.

20. The non-transitory, computer-readable medium of claim 16, wherein the first video chat includes text with the video indicating at least one common interest between the first and second users based on prior activity of the first and second users within a feed of the social media application.
